(19) United States
(12) Patent Application Publication
(10) Pub. No.: US 2015/0143870 A1
(43) Pub. Date: May 28, 2015

(54) AZIMUTH ANGLE CALIBRATION METHOD AND MOTION ANALYSIS APPARATUS

(71) Applicant: SEIKO EPSON CORPORATION, Tokyo (JP)

(72) Inventor: Kazuhiro SHIBUYA, Shiojiri-shi (JP)

(21) Appl. No.: 14/535,797

(22) Filed: Nov. 7, 2014

(30) Foreign Application Priority Data
Nov. 26, 2013 (JP) 2013-244158

(51) Int. Cl. G01B 5/24; G01P 15/02

(52) U.S. Cl. CPC G01B 5/24; G01P 15/02
USPC 73/1.75; 73/510

(57) ABSTRACT

A motion analysis apparatus includes a first calculation unit that calculates a first vector on a node in an absolute coordinate system using an output from a first inertial sensor attached to one of two rigid bodies linked by the node having a multiple degrees of freedom, a second calculation unit that calculates a second vector on the node in the absolute coordinate system using an output from a second inertial sensor attached to the other one of the rigid bodies; and a third calculation unit that calculates a difference in directions of the first vector and the second vector.

### BACKGROUND

1. Technical Field

The present invention relates to an azimuth angle calibration method, a motion analysis apparatus, and the like.

2. Related Art

A motion analysis apparatus is used for analyzing a motion such as a swing operation. Sporting equipment is shaken during swinging. When the sporting equipment is shaken, a grip of the sporting equipment is held by the hands. When the sporting equipment is shaken, the posture of the sporting equipment changes according to the time axis. An inertial sensor is attached to the sporting equipment. The swing operation is visually reproduced based on an output of the inertial sensor. As an example of such a motion analysis apparatus, for example, JP-A-2008-73210 discloses a golf swing analysis apparatus, JP-A-2008-73210 discloses that an inertial sensor is attached to each of two positions of a shaft and a head of a golf club which is a rigid body.

For example, in a case of performing the analysis of the golf swing, there is a case in which not only the Taction analysis of the golf club but also the motion analysis of the arm that operates the golf club is essential. In this case, the inertial sensor is attached to each of the golf club and the arm.

As described above, in a case of using two inertial sensors, since each inertial sensor is roughly attached, to the golf club and the arm, directions of detection axes of the two inertial sensors are not coincident with each other. If the swing analysis is performed in this state, the orientations of data measured by the two inertial sensors are not aligned. Therefore, two trajectories obtained by the two inertial sensors are reproduced as motions different from the actual motions, and thus, there is a problem in that the accuracy of the swing analysis decreases.

Particularly, since each posture of the golf club and the arm changes as a different rigid body, there is a problem in that it is difficult to align the orientations of the golf club and the arm.

### SUMMARY

An advantage of some aspects of the invention is to provide an azimuth angle calibration method and a motion analysis apparatus in which directions of vectors obtained iron two inertial sensors respectively attached to two rigid bodies linked by a node having multiple degrees of freedom, can be aligned.

(1) An aspect of the invention relates to an azimuth angle calibration method that includes calculating a first vector on a node in an absolute coordinate system using an output from a first inertial sensor attached to one of two rigid bodies linked by the node having a multiple degrees of freedom; calculating a second vector on the node in the absolute coordinate system using an output from a second inertial sensor attached to the other of the two rigid bodies; and calculating a difference between directions of the first vector and the second vector.

In an example of golf swing, there is a node having multiple degrees of freedom on a grip of a golf club held by the hand, and an arm and the golf club may be regarded as two rigid bodies linked by the node. If the first vector on the node in an absolute coordinate system calculated using the output from the first inertial sensor attached to one of the two rigid bodies and the second vector on the node in the same coordinate system calculated using the output from the second inertial sensor attached to the other one of the two rigid bodies have the same physical quantity, it is correct that the two vectors are in the same direction. If there is a difference in the directions of the first and the second vectors, the difference is an amount of calibration between the azimuth angles of the two vectors. Based on this amount of calibration, the azimuth angle calibration between a plurality of sensors can be performed.

(2) The azimuth angle calibration method according to the aspect of the invention may include: correcting at least one of the directions of the first vector and the second, vector based on the difference in the directions of the first vector and the second vector.

By correcting at least one of the directions of the first vector and the second vector based on the obtained amount of the calibration, the directions of the first and the second vectors on the node are coincident with each other.

(3) In the azimuth angle calibration method according to the aspect of the invention, each of the first inertial sensor and the second inertial sensor may include a three-axis acceleration sensor and a three-axis angular velocity sensor, and each of the first vector and the second vector may be a velocity vector of the node.

The velocity vector of the node can be calculated using the acceleration and the angular velocity from the first inertial sensor and the second inertial sensor. The velocity vector has less fluctuation or noise compared to the acceleration vector, and has a smaller cumulative error of integration compared to the position vector calculated by the integration of the velocity vector. Therefore, the velocity vector is suitable for the calculation of the amount of calibration.

(4) In the azimuth angle calibration method according to the aspect of the invention, the calculating of the first vector may include: firstly calculating acceleration of the node in a sensor coordinate system of the first inertial sensor using the angular velocity and the acceleration obtained from the output of the first inertial sensor and length information from the first inertial sensor to the node; firstly calculating a velocity of the node in the sensor coordinate system of the first inertial sensor by integrating the acceleration of the node obtained in the firstly calculating of the acceleration; firstly detecting a posture of a first rigid body using the angular velocity obtained from the output of the first inertial sensor; and firstly converting the velocity of the node in the sensor coordinate system of the first inertial sensor to the velocity of the node in the absolute coordinate system using the posture of the first rigid body obtained in the firstly detecting of the posture, and the calculating of the second vector may include: secondly calculating acceleration of the node in a sensor coordinate system of the second inertial sensor using the angular velocity and the acceleration obtained from the output of the second inertial sensor and length information from the second inertial sensor to the node; secondly calculating a velocity of the node in the sensor coordinate system of the second inertial sensor by integrating the acceleration of the node obtained in the secondly calculating of the acceleration; secondly detecting a posture of a second rigid body using the angular velocity obtained from the output of the second inertial sensor; and secondly converting the velocity of the node in the sensor coordinate system of the second inertial sensor to the velocity of the node in the absolute coordinate system using the posture of the second rigid body obtained in the secondly detecting of the posture.

As described above, the velocity of the node in the sensor coordinate system of the first inertial sensor can be obtained by converting the coordinate to the absolute coordinate system based on the posture of the rigid body obtained by the angular velocity from the first inertial sensor. In addition, the velocity of the node in the sensor coordinate system of the second inertial sensor can be obtained by converting the coordinate to the absolute coordinate system based on the posture of the rigid body obtained by the angular velocity from the second inertial sensor.

(5) Another aspect of the invention relates to a motion analysis apparatus that includes: a first calculation unit that calculates a first vector on a node in an absolute coordinate system using an output from a first inertial sensor attached to one of two rigid bodies linked by the node having multiple degrees of freedom; a second calculation unit that calculates a second vector on the node in the absolute coordinate system using an output from a second inertial sensor attached to the other one of the two rigid bodies; a third calculation unit that calculates a difference in directions of the first vector and the second vector; and a posture detection unit that detects a posture of at least one of a first rigid body and a second rigid body using the output of any of the inertial sensors, and in which azimuth angles of the first inertial sensor and the second inertial sensor are corrected based on the difference calculated by the third calculation unit.

By performing the motion analysis method, the directions of the vectors of the node between the first and the second rigid bodies are coincident with each other. Therefore, it is possible to correctly perform the motion analysis on the posture of at least one of the first rigid body and the second rigid body. The posture detection unit can be disposed inside either the first calculation unit or the second calculation unit.

(6) In the motion analysis apparatus according to the aspect of the invention, the first inertial sensor may be provided on sporting equipment and the second inertial sensor may be provided on an arm that operates the sporting equipment.

The sporting equipment and the arm may be regarded as two rigid bodies linked by the node on the grip portion of the sporting equipment held by the hand, and the swing analysis of the sporting equipment and the arm can be performed using the outputs of the first and the second inertial sensors provided on the sporting equipment and the arm.

In the motion analysis apparatus according to the aspect of the invention, one axis in the absolute coordinate system may be coincident with a target direction of a ball struck by the sporting equipment in a stationary state.

If one axis in the absolute coordinate system is the target direction of a ball struck by the sporting equipment in a stationary state and the other axis is the direction of gravity, a three-axes orthogonal coordinate system which is the absolute coordinate system can be determined as a coordinate system for performing the swing analysis easily.

Still another aspect of the invention relates to an azimuth angle calibration program that causes a computer to execute: a procedure of calculating a first vector on a node in an absolute coordinate system using an output from a first inertial sensor attached to one of two rigid bodies linked by the node having a multiple degrees of freedom; a procedure of calculating a second vector on the node in the absolute coordinate system using an output from a second inertial sensor attached to the other one of the two rigid bodies; a procedure of calculating a difference in directions of the first vector and the second vector; and a procedure of correcting azimuth angles of the first inertial sensor and the second inertial sensor based on the difference.

The azimuth angle calibration program can cause the computer to execute the operations of the motion analysis apparatus according to the another aspect of the invention. The program may be stored in the motion analysis apparatus from, the beginning, may be stored in a recording medium to be installed in the motion analysis apparatus, or may be downloaded from a server to a communication terminal of the motion analysis apparatus through a network.

### BRIEF DESCRIPTION OF THE DRAWINGS

The invention will be described with reference to the accompanying drawings, wherein like numbers reference like elements.

FIG. 1 is a conceptual diagram schematically illustrating a configuration of a golf swing analysis apparatus in an embodiment of the invention.

FIG. 2 is a conceptual diagram schematically illustrating a motion analysis model.

FIG. 3 is a schematic block diagram illustrating an azimuth angle calibration method.

FIG. 4 is a diagram for explaining a deviation of directions of a first and a second vectors with regard to a node in an absolute coordinate system.

FIG. 5 is a detailed block diagram illustrating an azimuth angle calibration method.

### DESCRIPTION OF EXEMPLARY EMBODIMENTS

Hereinafter, an embodiment of the invention will be described with reference to the drawings attached hereto. The content of the invention described in the appended claims is not limited to the present embodiment described hereafter, and all the configurations described in the embodiments are essential for the solutions in the invention.

### 1. Configuration of Golf Swing Analysis Apparatus

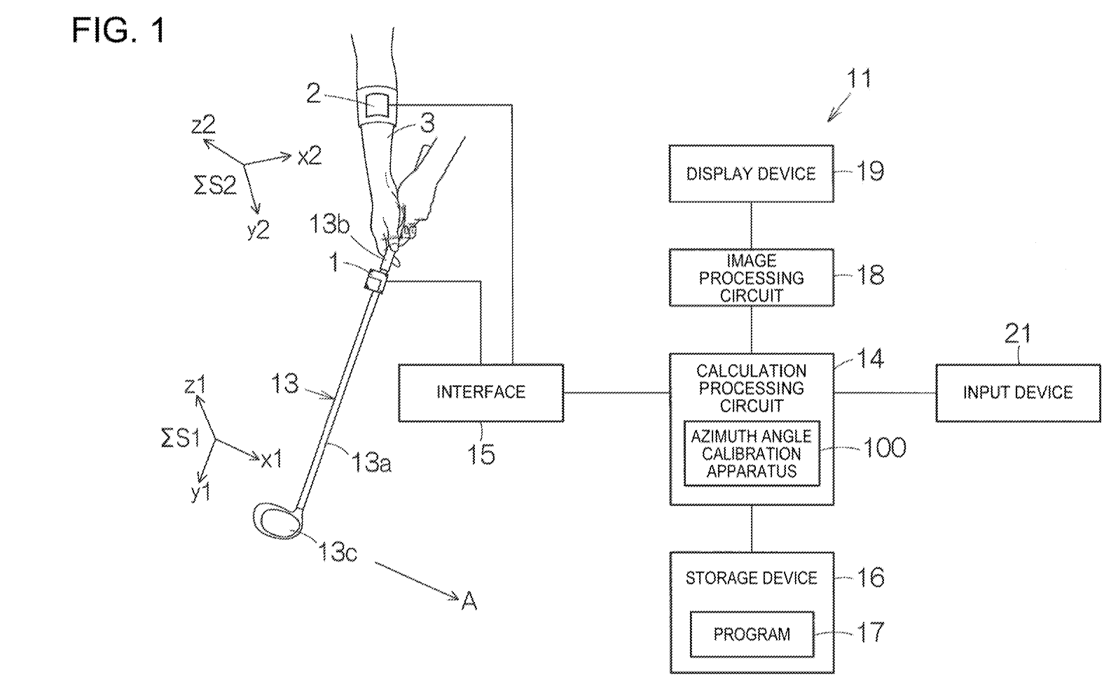

FIG. 1 schematically illustrates a configuration of a golf swing analysis apparatus (motion analysis apparatus) 11 according to an embodiment of the invention. To the golf swing analysis apparatus 11, a first inertial sensor 1 and a second inertial sensor 2 are connected. To each of the first inertial sensor 1 and the second inertial sensor 2, for example, an acceleration sensor or a gyro sensor (an angular velocity sensor) is incorporated. The acceleration sensor can detect the individual acceleration of each of directions x, y, and z of three mutually orthogonal axes. The gyro sensor can defect the individual angular velocity around each axis of x, y, and t of three mutually orthogonal axes. The first inertial sensor 1 and the second inertial sensor 2 respectively output the detection signal. With the detection signal, the acceleration and the angular velocity are specified for each individual axis.

The first inertial sensor 1 is attached to a golf club (sporting equipment) 13. The golf club 13 includes a shaft 13a and a grip 13b. The grip 13b is held by the hands. The grip 13b is formed, coaxially with the direction of the long axis along which the shaft 13a extends. To the distal end of the shaft 13a, a club head 13c is coupled. Desirably, the first inertial sensor 1 is attached to the shaft 13a or the grip 13b of the golf club 13. The first inertial sensor 1 may be relatively not movably fixed to the golf club 13. The second inertial sensor 2 is attached to a lower arm 3 between the wrist and elbow of the right arm of the right-handed subject. The second inertial sensor 2 may be relatively not movably fixed to the lower arm 3.

Here, in attaching the first inertial sensor 1, if the local coordinate system of the first inertial sensor 1 is x1, y1, and z1, the y axis, for example, is set to be parallel to the long axis along which the shaft 13a extends. The x1 axis that is the another detection axis of the first inertial sensor 1 Is set to be parallel to the target direction A that intersects the face surface of the club head 13c. The z1 axis that is the other detection axis of the first inertial sensor 1 is set to be, for example, orthogonal to the x1 axis and the y1 axis.

In contrast, in attaching the second inertial sensor 2, if a local coordinate system of the second inertial sensor 2 is x2, y2, and z2, the y2 axis, for example, is set to be parallel to the axis in the direction in which the lower arm

3 extends. The x2 axis that is another detection axis of the second inertial sensor 2 is set to be parallel to the x1 axis, for example, when the y1 axis and the y2 axis are parallel to each other. The z2 axis that is the other detection axis of the second inertial sensor 2 is set to be, tor example, orthogonal to the x2 axis and the y2 axis.

The golf swing analysis apparatus 11 includes a calculation processing circuit 14. The first inertial sensor 1 and the second inertial sensor 2 are connected to the calculation processing circuit 14. In the connection, a predetermined interface circuit 15 is connected to the calculation processing circuit 14. The interface circuit 15 may be connected to the first inertial sensor 1 and the second inertial sensor 2 by wiring or may be connected to the first inertial sensor 1 and the second inertial sensor 2 wirelessly. The detection signal is supplied from the first inertial sensor 1 and the second inertial sensor 2 to the calculation processing circuit 14.

A storage device 16 is connected to the calculation processing circuit 14. In the storage device 16, for example, a golf swing analysis software program (motion analysis program) 17 and the related data are stored. The calculation processing circuit 14 executes the golf swing analysis software program 17 and realizes the golf swing analysis method. The storage device 16 can include a DRAM (dynamic random access memory) , amass storage device unit, and a non-volatile memory. For example, in the DRAM, in performing the golf swing analysis method, golf swing analysis software program 17 is temporarily held. In the mass storage device unit such as a hard disk drive unit (HDD), the golf swing analysis software program 17 and data are stored. In the non-volatile memory, a comparatively small volume program such as BIOS (basic input output system) or data are stored.

An image processing circuit 18 is connected to the calculation processing circuit 14. The calculation processing circuit 14 sends predetermined image data to the image processing circuit 18. A display device 19 is connected to the image processing circuit 18. In the connection, a predetermined interface circuit (not illustrated) is connected to the image processing circuit 18. The image processing circuit 18 sends the image signal to the display device 19 according to the input image data. On the screen of the display device 19, an image specified by the image signal is displayed. As the display device 19, a liquid crystal display or a flat plane display is used. Here, the calculation processing circuit 14, the storage device 16 and the image processing circuit 18, for example, are provided as a computer apparatus.

An input device 21 is connected to the calculation processing circuit 14. The input device 21 includes at least alphabetic keys and numeric keys. Character information or numeric information is input to the calculation processing circuit 14 from the input device 21. The input device 21 may be, for example, formed of a keyboard. The combination of the computer apparatus and the keyboard may be replaced, for example, by a smart phone, a mobile phone terminal, or a tablet PC (a personal computer).

2. Motion analysis model

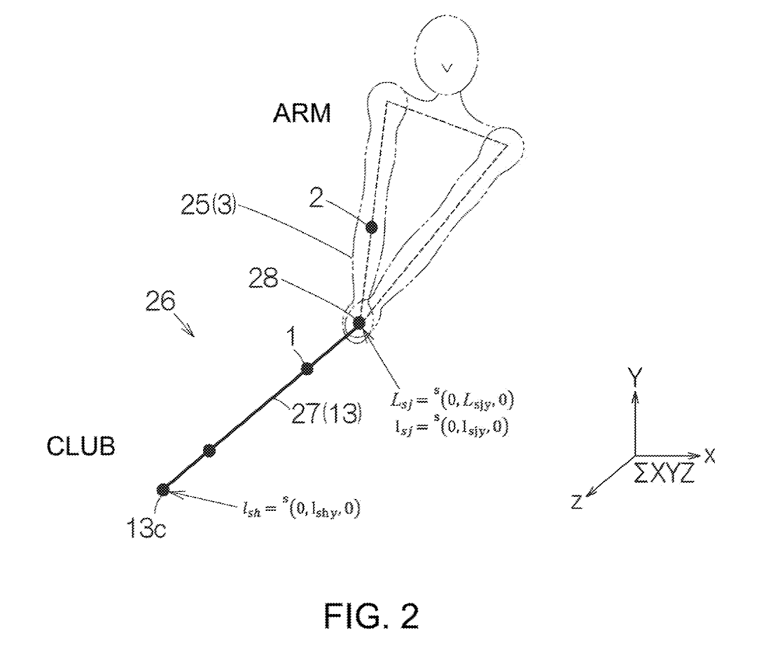

The calculation processing circuit 14 performs calculation processing based on a motion analysis model illustrated in FIG. 2. The motion analysis model will be described below. As illustrated in FIG. 2, an absolute reference coordinate system (global coordinate system) ΣXYZ is defined, and the motion analysis model 26 is built according to the absolute reference coordinate system ΣXYZ. The motion analysis model 26 is modeled with the golf club 13 as a first rigid body 27, the lower arm 3 as a second rigid body 25, and the first and the second rigid bodies 27 and 25 as link mechanisms linked at a node (a fulcrum) 28 in multiple degrees of freedom. The first rigid body 27 operates in three dimensions as a pendulum around the node (fulcrum) 28. The position of the node (fulcrum) 28 can be moved.

Each of the first inertial sensor I and the second inertial sensor 2 output the acceleration signal and the angular velocity signal. In the acceleration signal of the first inertial sensor 1, the acceleration αs1 (ax1, ay1, az1) including the acceleration of gravity g is specified, and in the angular velocity signal, angular velocity ωs1 (ωx1, ωy1, (ωz1) is specified. In the acceleration signal of the second inertial sensor 2, the acceleration αs2 (ax2, ay2, az2) including the acceleration of gravity g is specified, and in the angular velocity signal, angular velocity ωs2 (ωx2, ωy2, ωz2) is specified.

The calculation processing circuit 14 fixes the local coordinate system Σs1 specified by the coordinate (x1, y1, z1) to the first inertial sensor 1. The origin of the local coordinate system Σs1 is set to the origin of each detection axis of the first inertial sensor 1. According to the local coordinate system Σs1, a position 1sj of the node (fulcrum) 28 is specified on (0, lsjy, 0). Similarly, a position lsh of the club head 13c Is specified on (0, lshy, 0).

Similarly, the calculation processing circuit 14 fixes the local coordinate system Σs2 specified by the coordinate (x2, y2, z2) to the second inertial sensor 2. The origin of the local coordinate system Σs2 is set to the origin of each detection axis of the second inertial sensor 2.

According to the local coordinate system Σs2, a position Lsj of the node (fulcrum) 28 is specified on (0, Lsjy, 0).

### 3. Azimuth Angle Calibration Apparatus

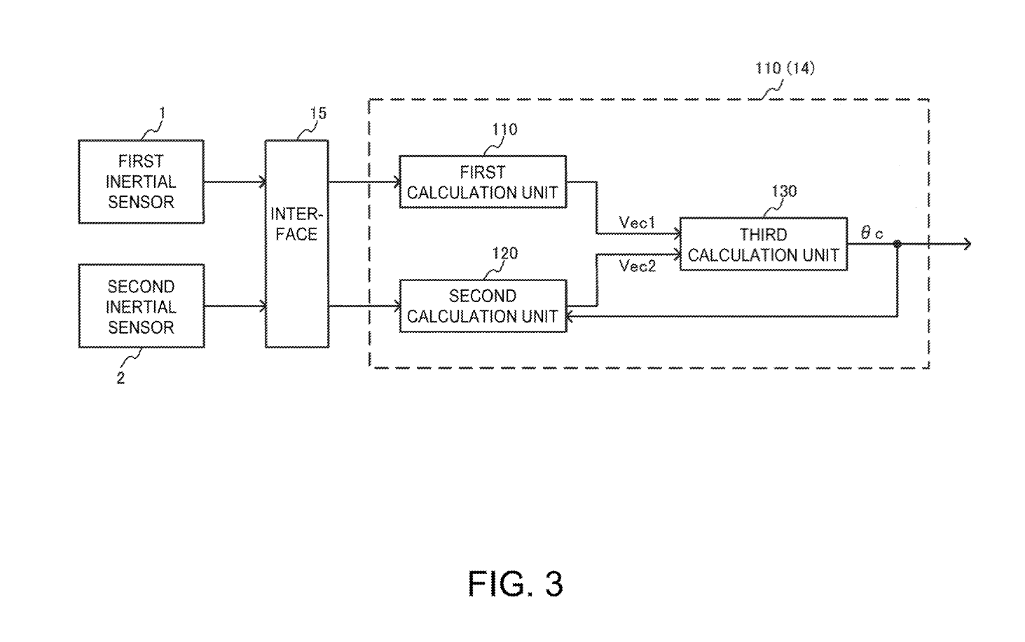

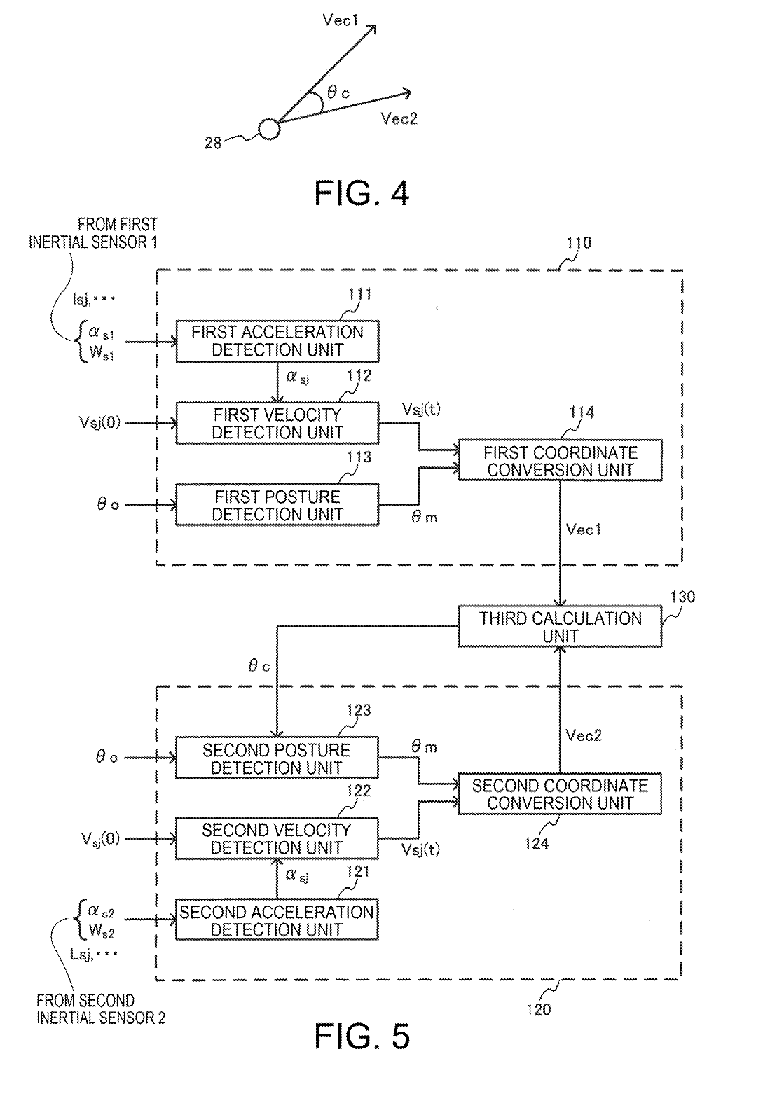

The azimuth angle calibration apparatus 100 provided on the calculation processing circuit 14 illustrated in FIG. 1 will be described with reference to FIG. 3. The azimuth angle calibration apparatus 100 includes first to third calculation units 110 to 130. The first calculation unit 110 calculates a first vector Vec1 on the node 28 in the absolute coordinate system ΣXYZ using the output from the first inertial sensor 1 that is attached to the golf club 13 which is one of the two rigid bodies linked by the node 28 having multiple degrees of freedom. The second calculation unit 120 calculates a second vector Vec2 of which the physical quantity is the same as that of the first vector Vec1, on the node 28 in the absolute coordinate system ΣXYZ using the output from the second inertial sensor 2 that is attached to the lower arm 3 which is the other one of the two rigid bodies. Here, both of the first and the second vectors Vec1 and Vec2 are any of a velocity vector, an acceleration vector, or a position vector. The third calculation unit 130 calculates a difference θc of the directions of the first vector Vec1 and the second vector Vec2 schematically illustrated in FIG. 4.

Here, there is the node 28 having multiple degrees of freedom on the grip 13b of the golf club 13 held by the hand, and the lower arm 3 and the golf clab 13 can be regarded as two rigid bodies linked by the node 28. If the first vector Vec1 on the node 26 in the absolute coordinate system ΣXYZ calculated by the first calculation unit 110 using the output from the first inertial sensor 1 attached to one of the two rigid bodies 3 and 13 and the second vector Vec2 on the node 28 in the same coordinate system calculated by the second calculation unit 120 using the output from the second inertial sensor 2 attached to the other one of the two rigid bodies 3 and 13 have the same physical quantity (any of the velocity vector, acceleration vector, or the position vector), it is correct that, originally, the two vectors are in the same direction. If there is a the difference θc between the directions of the first vector Vec1 and the second vector Vec2, the difference θ8c is an amount of calibration between the azimuth angle of the two vectors. The third calculation unit 130 can calculate the amount of calibration θc. The third calculation unit 130 can output the amount of calibration θc to the outside of the azimuth angle calibration apparatus 100. Based on the amount of calibration θc, the initial position around the detection axis is set with regard to any one of the first and the second inertial sensors 1 and 2, and then, an azimuth angle calibration can be performed.

For example, in a case where the first and the second vectors Vec1 and Vec2 are used for the motion analysis of the lower arm 3 and the golf club 13, the third calculation unit 130 can correct the direction of any one of the first vector Vec1 and the second vector Vec2, for example, the direction of the second vector Vec2 based on the amount of calibration θc. The third calculation unit 130 can change the initial condition θ0 (initial position around, each axis) which is set when the second vector Vec2 is calculated by the second calculation unit 120, to θc. In this way, by correcting the direction of the second vector Vec2, the directions of the first and the second vectors Vec1 and Vec2 on the node 28 can be coincident with each other, and thus, the azimuth angle calibration can be performed.

Here, each of the first vector Vec1 and the second vector Vec2 can be the velocity vector of the node 28. The velocity vector of the node 28 can be calculated using the acceleration and the angular velocity from the first and the second inertial sensor 1 and 2 as described below. That is because the velocity vector has a less fluctuation or noise compared to the acceleration vector, and has a less cumulative error of integration compared to the position vector calculated by the integration of the velocity vector, and thus, the velocity vector is suitable for the calculation of the amount of calibration.

The first calculation unit 110, as illustrated in FIG. 5, includes a first acceleration detection unit 111, a first velocity detection unit 112, a first posture detection unit 113, and a first coordinate conversion unit 114. The second calculation unit 120, as illustrated in FIG. 5, includes a second acceleration detection unit 121, a second velocity detection unit 122, a second posture detection unit 123, and a second coordinate conversion unit 124.

The first acceleration detection unit 111 calculates the acceleration αsj1 of the node 28 in the sensor coordinate system Σs1 of the first inertial sensor 1 using the angular velocity ωs1 and the acceleration αs1 from the first inertial sensor 1 and the length information (l_{sjy}) from the first inertial sensor 1 to the node 28. Similarly, the second acceleration detection unit 121 calculates the acceleration αsj2 of the node 28 in the sensor coordinate system Σs2 of the second inertial sensor 2 using the angular velocity ωjs2 and the acceleration as 2 from the second inertial sensor 2 and the length information (L_{sjy}) from the second inertial sensor 2 to the node 28. The acceleration αsj1 calculated in the first acceleration detection unit 111 is obtained by Formula 1. The acceleration αsj2 calculated in the second acceleration detection unit 121 is obtained by Formula 2.

αₛⱼ₁=αₛ₁+ωₛ₁ ×lₛⱼ₁×(ωₛ₁×lₛⱼ₁)+g [Formula 1]

αₛⱼ₂=αₛ₂+ωₛ₂×lₛⱼ₂+ωₛ₂×(ωₛ₂×lₛⱼ₂)+g [Formula 2]

The first velocity detection unit 112 calculates the moving velocity Vsj1 (t) of the node 28 based on the acceleration αsj1 calculated in the first acceleration detection unit 111 and, for example, the initial condition Vsj1(0)=0 of the stationary state. Similarly, the second velocity detection unit 122 calculates the moving velocity Vsj2 (t) of the node 28 based on the acceleration αj2 calculated in the second acceleration detection unit 121 and, for example, the initial condition Vsj2 0)=0 of the stationary state. Here, according to Formula 3 and Formula 4, the integration processing is performed on the acceleration αsj1 and the acceleration αsj2 in a specified sampling interval dt.

$$\begin{matrix}{V}_{s j 1} ( 0 ) = 0 \\ {V}_{sj 1} ( t ) = {\sum }_{n = 1}^{t} {a}_{s j 1} ( n ) \cdot d t ( t = 1 , … , N ) & [ Formula 3 ] \\ {V}_{s j 2} ( 0 ) = 0 \\ {V}_{sj 2} ( t ) = {\sum }_{n = 1}^{t} {a}_{s j 2} ( n ) \cdot d t ( t = 1 , … , N ) & [ Formula 4 ]\end{matrix}$$

Here, each of the first posture detection unit 113 and the second posture detection unit 123 calculates the posture of the inertial sensor 1 or the inertial sensor 2 for each sampling point based on the angular velocity around the three axes. In the calculation, for example, the rotation matrix Rs is specified from the angular velocity using Formula 5.

$$Rs = ( \begin{matrix}{w}^{2} + {x}^{2} - {y}^{2} - {z}^{2} & 2 ( xy - wz ) & 2 ( xz + wy ) \\ 2 ( xy + wz ) & {w}^{2} - {x}^{2} + {y}^{2} - {z}^{2} & 2 ( yz - wx ) \\ 2 ( xz - wy ) & 2 ( yz + wx ) & {w}^{2} - {x}^{2} - {y}^{2} + {z}^{2}\end{matrix} ) \qquad [ Formula 5 ]$$

Here, in specifying the rotation matrix Rs, a quaternion Q is specified.

$$Q = ( w , x , y , z ) \\ w = cos \frac{θ}{2} \\ x = \frac{ω x}{\vert \vec{ω} \vert} \cdot sin \frac{θ}{2} \\ y = \frac{{ω}_{y}}{\vert \vec{ω} \vert} \cdot sin \frac{θ}{2} \\ z = \frac{{ω}_{z}}{\vert \vec{ω} \vert} \cdot sin \frac{θ}{2} \qquad [ Formula 6 ]$$

Here, the magnitude of the angular velocity is calculated by following Formula.

| ω̅=\sqrt{ωₓ²+ω_{y}²+ω_{z}²} [Formula 7]

However, the measured angular velocity [rad/s] is expressed by following Formula.

ω̅=(ω_{x′}ω_{y′}ω_{z}) [Formula 8]

The angle θ per unit time Δt [rad] is calculated by following Formula,

θ=| ω̅| [Formula 9]

By inputting the angular velocity information from the first posture detection unit 113 or the angular velocity information from the second posture detection unit 123 into the above described ωx, ωy, and ωz, the rotation matrix Rs in each of the first inertial sensor 1 and the second inertial sensor 2 can be obtained.

The first coordinate conversion unit 114 converts the velocity Vsj1 (t) of the node in the sensor coordinate system Σs1 of the first inertial sensor 1 to the velocity of the node 28 in the absolute coordinate system ΣXYZ using the rotation matrix Rs. The second coordinate conversion unit 124 converts the velocity Vsj2 (t) of the node in the sensor coordinate system Σs2 of the second inertial sensor 2 to the velocity of the node 26 in the absolute coordinate system ΣXYZ using the rotation matrix Rs.

By the calculation processing described above, the velocity vector of the node in the sensor coordinate system of the first inertial sensor 1 is converted to the velocity vector of the node in the absolute coordinate system, and the velocity vector of the node in the sensor coordinate system of the second inertial sensor 2 is converted to the velocity vector of the node in the absolute coordinate system.

The difference θc between the two vectors becomes the amount of calibration between the azimuth angles of the two vectors. The third calculation unit 130 calculates the amount of calibration θc. The third calculation unit 130 can output the amount of calibration θc to the outside of the azimuth angle calibration apparatus 100. Based on the amount of calibration θc, the azimuth angle calibration is performed on any one of the first and the second inertial sensors 1 and 2, and thus, the azimuth angles of the first inertial sensor 1 and the second inertial sensor 2 can be coincident with each other.

### 4. Operation of the Golf Swing Analysis Apparatus

The operation of the golf swing analysis apparatus 11 will be briefly described. First, a golf swing of a golfer is measured. Prior to the measurement, information necessary for the measurement is input to the calculation processing circuit 14 from the input device 21. Here, according to the motion analysis model 26, the positions lsj and Lsj of the node (fulcrum) 28 according to the local coordinate systems Σs1 and Σs2 and the initial postures of the first and the second inertial sensors 1 and 2 are facilitated to be input.

Prior to performing the golf swing, the measurement by the first and the second inertial sensors 1 and 2 starts. At the time of starting the operation, the first and the second inertial sensors 1 and 2 are set to a predetermined position and posture. The position and the posture correspond to a position and posture specified as the initial posture. The first and the second inertial sensors 1 and 2 continuously measure the acceleration and the angular velocity in a specific sampling interval. The sampling interval defines a resolution of the measurement. A detection signal from the first and the second inertial sensors 1 and 2 is sent into the calculation processing circuit 14 in real time. The calculation processing circuit 14 receives a signal that specifies the output of the first and the second inertial sensors 1 and 2.

In this initial stage, the azimuth angle calibration is performed by the azimuth angle calibration apparatus 100. Then, the motion analysis data is collected. The golf swing starts with an address and ends with a follow-through and a finish via a take-back, a halfway back, top, a down swing and an impact. When the golf club 13 is swung, the posture of the golf club 13 or the subject changes according to the time axis. The first inertial sensor 1 outputs the detection signal according to the posture of the golf club 13 or the subject. Based on the detection signal at the time of a swing operation, the posture, the position, the velocity, and the acceleration of the golf club 13 or the lower arm 3 are calculated according to the time axis. Accordingly, the swing analysis data of the lower arm 3 or the golf club 13 can be collected. If the swing image data is displayed on the display device 19, the swing analysis can be performed.

The present embodiment is described in detail as above. However, it can easily be understood by the skilled in the art that many variations without substantially departing from new matters and the advantages of the invention can be made. Therefore, all of those variations may be included in the invention. For example, in the specification or in the drawings, a term described at least once with a different term having a broad or a synonymous meaning can be replaced by the different term in any part in the specification or the drawings. In addition, the configurations and the operations of the first and the second inertial sensors 1 and 2 or the calculation processing circuit 14, the motion analysis model 26, and the azimuth angle calibration apparatus 100 are not limited to the description in the present embodiment, and various modifications can be made. In addition, the motion analysis to which the invention is applied can suitably be performed not only on the equipment for golf but also particularly on the striking sporting equipment for such as tennis or table tennis.

The entire disclosure of Japanese Patent Application No. 2013-244158, filed Nov. 26, 2013 is expressly incorporated by reference herein.

What is claimed is:

1. An azimuth angle calibration method comprising:
calculating a first vector on a node in an absolute coordinate system using an output from a first inertial sensor attached to one of two rigid bodies linked by the node;
calculating a second vector on the node in the absolute coordinate system using an output from a second inertial sensor attached to the other one of the two rigid bodies;
calculating a difference in directions of the first vector and the second vector; and
correcting at least one of the directions of the first vector and the second vector based on the difference in the directions of the first vector and the second vector.

2. The azimuth angle calibration method according to claim 1,
wherein the first vector and the second vector are velocity vectors.

3. The azimuth angle calibration method according to claim 1,
wherein the first inertial sensor and the second inertial sensor detect an angular velocity and acceleration.

4. The azimuth angle calibration method according to claim 3,
wherein the calculating of the first vector includes
firstly calculating acceleration of the node in a sensor coordinate system of the first inertial sensor using the angular velocity and the acceleration obtained from the output of the first inertial sensor and length information from the first inertial sensor to the node;
firstly calculating a velocity of the node in the sensor coordinate system of the first inertial sensor by integrating the acceleration of the node obtained in the firstly calculating of the acceleration;
firstly detecting a posture of a first rigid body using the angular velocity obtained from the output of the first inertial sensor; and
firstly converting the velocity of the node in the sensor coordinate system of the first inertial sensor to the velocity of the node in the absolute coordinate system using the posture of the first rigid body obtained in the firstly detecting of the posture to make the first vector, and
wherein the calculating of the second vector includes
secondly calculating acceleration of the node in a sensor coordinate system of the second inertial sensor using the angular velocity and the acceleration obtained from the output of the second inertial sensor and length information from the second inertial sensor to the node;
secondly calculating a velocity of the node in the sensor coordinate system of the second inertial sensor by integrating the acceleration of the node obtained in the secondly calculating of the acceleration;
secondly detecting a posture of a second rigid body using the angular velocity obtained from the output of the second inertial sensor; and
secondly converting the velocity of the node in the sensor coordinate system of the second inertial sensor to the velocity of the node in the absolute coordinate system using the posture of the second rigid body obtained In the secondly detecting of the posture to make the second vector.

5. A motion analysis apparatus comprising:
a first calculation unit that calculates a first vector on a node in an absolute coordinate system using an output from a first inertial sensor attached to one of two rigid bodies linked by the node;
a second calculation unit that calculates a second vector on the node in the absolute coordinate system using an output from a second inertial sensor attached to the other one of the two rigid bodies; and
a third calculation unit that calculates a difference in directions of the first vector and the second vector,
wherein at least one of the directions of the first vector and the second vector is corrected based on the difference calculated by the third calculation unit.

6. The motion analysis apparatus according to claim 5,
wherein the first inertial sensor is mounted on sporting equipment and the second inertial sensor is mounted on a subject who operates the sporting equipment,

7. The motion analysis apparatus according to claim 6,
wherein, in a three-axes orthogonal coordinate system that configures the absolute coordinate system, a first axis is a target direction of a hit ball and a second axis is the direction of gravity.
